(19) United States
(12) Patent Application Publication
(10) Pub. No.: US 2012/0011921 A1
(43) Pub. Date: Jan. 19, 2012

(54) METHOD FOR IMPROVING THE EFFICIENCY OF HIGH-PRESSURE LIQUID CHROMATOGRAPHY

(75) Inventors: Ken Broeckhoven, Edegem (BE); Jeroen Billen, Hasselt (BE); Gert Desmet, Elewijt (BE)

(73) Assignee: Vrije Universiteit Brussel, Brussel (BE)

(21) Appl. No.: 13/259,129

(22) PCT Filed: Mar. 26, 2010
(86) PCT No.: PCT/EP10/54033

§ 371 Date: Sep. 22, 2011

(30) Foreign Application Priority Data
Mar. 27, 2009 (EP) 09156411.2

(51) Int. Cl. G01N 30/02

(52) U.S. Cl. 73/61.53

(57) ABSTRACT

The present invention relates to a method for improving the efficiency of high-pressure liquid chromatography columns in HPLC. More specifically, the method of the present invention provides a high-pressure liquid chromatography column being divided into a multitude of shorter separation segments, the shorter separation segments being serially connected with cooling segments. By applying an active controlled cooling action on the fluid flow passing through the cooling segments the separation efficiency of the high-pressure liquid chromatography column can be increased significantly.

### FIELD OF THE INVENTION

The present invention relates to a method for improving the efficiency of high-pressure liquid chromatography columns in HPLC. More specifically, the method of the present invention provides a high-pressure liquid chromatography column being divided into a multitude of shorter separation segments, the shorter separation segments being serially connected with at least one cooling segment. By applying an active controlled cooling action on the fluid flow passing through the cooling segments the separation efficiency of the high-pressure liquid chromatography column can be increased significantly.

### BACKGROUND OF THE INVENTION

At present high-pressure liquid chromatography (HPLC) is a commonly known and worldwide used technology wherein a separation column enables the separation, identification and quantification of compounds. HPLC utilizes a separation column that holds chromatographic packing material or stationary phase, a pump that moves the mobile phases through the column, and a detector that shows the retention times of the compounds. Retention time varies depending on the stationary phase, the compounds and the mobile phase.

Improvements of HPLC techniques have primary been focussed towards the use of separation columns packed with particles of decreasing size. Decreasing the particle size leads to smaller values of the plate height and faster optimum velocities. However, due to the pressure limitations of the existing HPLC equipment there is a pressure limit of about 400 bar.

One of the latest developments in the field of liquid chromatography, is the development of instruments enabling ultra high-pressure liquid chromatography wherein the inlet pressures have been increased to 1000 bar and even up to 4000 bar. The use of these ultra-high pressures enables increased mobile phase velocities and the use of smaller stationary phase particles which are kinetically more advantageous.

The use of higher pressures is however limited because of the temperature gradients that are being formed inside the separation columns. These temperature gradients are caused by the viscous friction heat dissipation that becomes significant at sufficiently large pressure gradients. The amount of heat generated equals the product of flow rate and pressure drop over the separation column ΔP. The generated heat is very significant especially where separation columns packed with micron-sized particles are used. To enable sufficiently fast flows through separation columns packed with micron-sized particles generated, very high pressure drops need to be generated.

When temperature gradients occur in a separation column, these disturb the separation efficiency of the separation column

To reduce or even remove the heat generated inside a separation column several possibilities have already been considered, but they all create a temperature gradient. Heat can be removed from the separation column by operating in an isothermal manner, thereby removing the heat radially (and thus creating a radial gradient) or by operating in an adiabatic manner, thereby removing the heat axially from the column (and thus creating an axial gradient).

When operating the separation column in an isothermal manner, the separation column is operated at a constant temperature, thereby maintaining the temperature constant over the entire column wall. However, the isothermal conditions are known to have a detrimental effect on the separation efficiency of the separation column. The isothermal conditions cause a radial temperature gradient inside the column and induce a radial velocity gradient which in turn gives rise to an additional plate height contribution which is proportional to the column radius raised to the 6th power. This reduces the separation efficiency of isothermally operated separation columns.

When operating the separation column in an adiabatic manner, the separation column is thermally insulated prohibiting heat to be dissipated from the column wall. These adiabatic conditions induce an axial temperature gradient along the separation column instead of a radial temperature gradient. However, because of the finite thermal capacity of the column wall, the backflow of heat that occurs in the column wall still induces a radial thermal gradient, thereby again provoking an additional plate height contribution and reducing the separation efficiency of adiabatic operated separation columns.

Furthermore, another drawback of the adiabatic operation mode is that the generated heat leaves the column only through the exit of the separation column. Consequently, when operated at 1000 and 2000 bar, the temperature at the column exit can be respectively about 15° C. and 30° C. larger than at the inlet. This temperature increase results in several undesired side-effects, including analyte instability, loss of retention strength and unpredictable band broadening. Additionally, because the generated heat depends on the physicochemical properties of the mobile phase and because the latter is subjected to steep changes during for instance gradient-elution separation mode, the amount of generated heat, and hence the column temperature, varies over time. Given the relatively large thermal mass of the columns, the temperature prevailing in the column typically depends upon the pumping and mobile phase composition history of the past 10 to 20 minutes. Given that many of the key parameters that determine the quality of a separation, such as molecular diffusivity and adsorption equilibrium, are highly temperature-specific, the variable column temperature inevitably makes the chromatographic separations less reproducible.

International patent application WO 01/67080 describes a thermostat array of two or more capillary columns each column being surrounded with a heat conductive material forming a heater body. A temperature controller is connected to a thermostat or heater body surrounding a column to measure the temperature on the outside of the heater body, and to provide feedback in order to control the required temperature adjustment of the heater. Providing a radial heat transfer, this arrangement will increase the radial temperature gradients, which is absolutely to be avoided in order not to ruin the efficiency of the separation.

European patent application EP 1 876 453 relates to a microfluidic chip for performing chromatography having an integrated heat exchanger positioned between a trap column and an analytical column, which ensures heating of the sample prior to entry into the analytical column. The alteration of the temperature by the integrated heat exchanger therefore occurs between two different operations. Hence, by changing the temperature only prior to the analytical column, EP 1 876 453 does not provide a solution to remove the heat generated inside an analytical separation column. Furthermore, microfluidic chromatography devices are limited in their operating pressure, often working at pressures lower than 200 bar (i.e., well below the pressures used in HPLC or HPLC at pressures of 400 or more bar) in order not to jeopardize the integrity of the microfluidic chip. In addition, the diameter of the separation channels is typically 10 times smaller than HPLC columns normally used in liquid chromatography (typically 2 to 4 mm). Since the viscous heating effect only emanates in systems with a pressure in the range of 400 bar and above and in columns with a diameter of 1 mm and more, the viscous heating effect simply does not exist in microfluidic separation devices. This also explains why EP 1 876 453 does not disclose what heat exchanger capacity would be needed to enable the removal of the heat generated by viscous heating in an analytical column. The amount of heat generated in an analytical column equals the product of flow rate through the column and pressure drop over the column. In HPLC, the generated heat is significant, because of the very high pressure drops required to generate a sufficiently fast flow through beds packed with micron-sized particles.

In view of the above, there remains a pressing need to develop small and normal bore (1 to 5 mm diameter) HPLC separation columns which enable the dissipation of heat generated by the viscous friction in a more effective manner. Especially when HPLC columns are operated at pressures above 1000 bar, it is necessary to reduce or remove the creation of a radial thermal gradient inside the separation column, this without creating an excessively large axial temperature gradient. Separation columns provided with these characteristics would allow to increase the applicable pressure from the currently available 1000 bar to 2000, 3000 or 4000 bar and even higher, hence opening a new range of unprecedented separation resolutions and speeds.

In the present invention it has been unexpectedly found that by dividing a separation column into a multitude of shorter separation segments, interconnecting the shorter separation segments with cooling segments, and applying an active controlled cooling action on the fluid flow passing through the cooling segments, the viscous friction heat generated in the shorter separation columns can be removed efficiently, while the additional band broadening that occurs when operating a separation column in an isothermal or adiabatic manner remains insignificant.

### SUMMARY OF THE INVENTION

The present invention provides methods for enhancing the separation efficiency of separation columns in HPLC. In the present invention methods are provided where a high-pressure liquid chromatography column is divided into a multitude of shorter separation segments, interconnected by cooling segments wherein an active controlled cooling action is applied on the fluid flow passing through the cooling segments. Consequently, the viscous friction heat generated in the shorter separation segments can be removed efficiently, while the additional band broadening that occurs when operating a high-pressure liquid chromatography column in an isothermal or adiabatic manner remains insignificant.

In a first embodiment, the present invention regards methods for the separation of a sample in a high-pressure liquid chromatography column, wherein said sample is forced through a separation segment of said column, subsequently cooled in a cooling segment of said column and further forced through a subsequent separation segment of said column. The methods of the present invention consequently improve the separation efficiency of high-pressure liquid chromatography columns.

In particular embodiments of the methods of the invention, the diameter of the fluid passage way of the cooling segment is smaller than the diameter of the fluid passage way of the separation segments.

In particular embodiments, the present invention relates to methods comprising the subsequent steps of,

(a) separating a sample in a first separation segment, thereby providing a partially separated sample;
(b) cooling said partially separated sample in a further cooling segment, thereby providing a cooled partially separated sample;
(c) further separating said cooled partially separated sample is a subsequent separation segment, thereby providing a further partially separated sample; and;
(d) optionally repeating once or more the steps (b) and (c).

More preferably steps (b) and (c) are repeated at least once, at least twice, at least 3 times, at least 4 times or at least 5 times.

In particular embodiments of the methods of the invention, the fluid passage way of the cooling segment comprises a stationary phase or a dispersion reducing medium.

In particular embodiments of the methods of the invention, the fluid passage way of the cooling segment is embedded in a heat exchanger and preferably a heat exchanger using fluid or fan cooling.

In particular embodiments of the methods of the invention the heat exchanger controls the cooling of fluid passing through the cooling segment by receiving temperature information from at least one temperature sensor located on or in the fluid passage way of the cooling segment and/or at least one temperature sensor located at the inlet of the fluid passage way of the subsequent separation segment.

In particular embodiments of the methods of the invention the operating pressures of the high-pressure liquid chromatography are larger than 400 bar, and preferably larger than 1000 bar.

Another aspect of the present invention regards high-pressure liquid chromatography columns characterized therein that said columns comprise at least two separation segments and at least one cooling segment, wherein said cooling segment is arranged between at least two of said serially coupled separation segments. By providing an arrangement of cooling segments in between the separation segments, the temperature of the fluid coming out of the first separation segment can be reduced in the cooling segment prior to flowing through the subsequent separation segment.

Another embodiment of the present invention relates to a chromatographic system comprising an injector, preferably performing time-pulsed injections, a detector, connection capillaries, and a high-pressure liquid chromatography column according to the present invention.

These and further aspects and embodiments are described in the following sections and in the claims.

### BRIEF DESCRIPTION OF FIGURES

FIG. 1 provides the evolution of the temperature in a single high-pressure liquid chromatography column.

FIG. 2 provides the evolution of the temperature in a high-pressure liquid chromatography column comprising separation and cooling segments.

FIG. 3 provides a detailed view of a cooling segment interconnecting two serially coupled separation segments.

FIG. 4 provides yet another detailed view of a cooling segment.

FIG. 5 provides a cooling segment provided with temperature measurement and control means.

FIG. 6 provides experimental data regarding the temperature change in a single high-pressure liquid chromatography column.

FIG. 7 provides experimental data regarding the temperature change in a high-pressure liquid chromatography column comprising separation and cooling segments.

FIG. 8 provides a comparison of the experimentally measured temperatures of the column and capillary walls retrieved from a 10 cm long column (left) and two coupled 5 cm long columns (right) with intermediate active cooling according to the present invention.

FIG. 9 provides a comparison of the experimentally measured temperatures of the column and capillary walls retrieved from two three-segment systems (3×5 cm), one without (a) and one with active cooling (b).

FIG. 10 represents chromatograms of a separation on a 15 cm long column with increasing flow rate (a-d), at a fixed flow rate but for a coupled system without (e) and with active cooling (f).

### DETAILED DESCRIPTION OF THE INVENTION

Before the present method and devices used in the invention are described, it is to be understood that this invention is not limited to particular methods, components, or devices described, as such methods, components, and devices may, of course, vary. It is also to be understood that the terminology used herein is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein may be used in the practice or testing of the present invention, the preferred methods and materials are now described.

In this specification and the appended claims, the singular forms “a”, “an”, and “the” include plural references unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps.

The terms “comprising”, “comprises” and “comprised of” also include the term “consisting of”.

The term “about” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” refers is itself also specifically, and preferably, disclosed.

The recitation of numerical ranges by endpoints includes all numbers and fractions subsumed within the respective ranges, as well as the recited endpoints.

The present invention provides methods and devices that enable performing HPLC at pressures above 400 bar and even above 1000 bar without the creation of a radial thermal gradient inside a high-pressure liquid chromatography column that significantly reduces the efficiency of the high-pressure liquid chromatography column. Additionally the present invention also prevents the creation of an excessively large axial temperature gradient. Consequently, the high-pressure liquid chromatography columns provided with these characteristics allow to increase the applicable pressure from the currently available 400 bar to 1000, 2000, 3000 or even 4000 bar and more, hence opening a new range of unprecedented separation resolutions and speeds.

The present invention therefore provides a method wherein high-pressure liquid chromatography column is divided into a multitude of shorter separation segments, the shorter separation segments being serially interconnected with cooling segments, and by applying an active controlled cooling action on the fluid flow passing through the cooling segments, the viscous friction heat generated in the shorter separation columns can be removed efficiently, while the additional band broadening that occurs when operating a separation column in a isothermal of adiabatic manner remains insignificant. Whereas a skilled person would expect that the serial connection of a multitude of shorter separation columns would reduce the efficiency of the separations, the inventors have found that the introduction of actively cooling the fluid flow passing through the cooling segments provides an efficient manner to dissipate the viscous friction heat generated in the separation columns, hence enhancing the efficiency of the separation system in total. The inventors have further found that the viscous friction heat generated in the shorter separation segments can be efficiently removed by the cooling segments while the addition of the cooling segments only results in minimal additional band broadening compared to high-pressure liquid chromatography columns operated in an isothermal or adiabatic manner. The present invention is particularly directed to the removal of heat at intermediate positions along the trajectory of an operation that one would normally do in one device (separation column) if there would be no viscous heating problem.

In a first embodiment, the present invention regards a method for the separation of a sample in a high-pressure liquid chromatography column, wherein said sample is forced through a separation segment of said column, subsequently cooled in a cooling segment of said column and further forced through a subsequent separation segment of said column, and preferably a high-pressure liquid chromatography column wherein the diameter of the fluid passage way of said cooling segment is smaller than the diameter of the fluid passage way of said separation segments. Preferably, the diameter of the fluid passage way of said cooling segment is at least 2, at least 5, at least 10, at least 25, at least 50, at least 75, at least 100, at least 250, at least 500, at least 750, at least 1000, at least 1250, at least 1500, at least 1750 or at least 2000 times smaller than the diameter of the fluid passage way of said separation segments. The method of the present invention consequently improves the separation efficiency of high-pressure liquid chromatography columns.

As used herein, the term “separation efficiency” is generally defined as a number of theoretical plates, calculated as the second order spatial moment of a species band divided by the square of the distance this band has elapsed in the column.

As used herein, the term “high-pressure liquid chromatography column” or “separation column” refers to a separation system as a whole that enables the separation of a sample mixture into its different compounds. The high-pressure liquid chromatography column, according to the present invention, comprises a multitude of separation segments, each separation segment being provided with a stationary phase packed within a tube or column. The stationary phase may refer to particles forming a solid stationary phase or to a support coated with a stationary phase or to any type of stationary phase known to a person skilled in the art.

In a preferred embodiment said high-pressure liquid chromatography column comprises at least 2, at least 3, at least 4, at least 5, at least 6, at least 7, at least 8, at least 9, at least 10, at least 15, at least 20 or at least 25 separation segments wherein at least two serially coupled separation segments are connected through at least one cooling segment. The number of separation segments comprised in the high-pressure liquid chromatography column is however not limited.

The present invention preferably relates to methods and devices involving a high pressure liquid separation column, wherein the HPLC column is divided into “separation segments” interconnected through at least one cooling segment. In particular embodiments, the at least two separation segments having a cooling segment arranged between them have one or more properties which are the same, for instance they are identical in size, volume capability, fluid separation properties, stationary phase and/or other characteristics. More particularly, the at least two separation segments contain the same stationary phase and the cooling element in fact represents a physical division within one long separation column. More particularly, the sum of the different separation segments used in the methods according to the invention corresponds to the column. In further particular embodiments the at least two separation segments having a cooling segment between them are completely identical.

In particular embodiments of the present invention at least 2 of the separation segments comprised in said high-pressure liquid chromatography column are provided with a different type of stationary phase, enabling the separation of more complex sample mixtures. Examples of typically stationary phases employed as chromatographic supports are porous or non-porous particles, monolithic media, micro-pillars and/or fibres.

The term separation segment also covers individual commercial chromatographic columns known to those skilled in the art. In some embodiments, the separation element can itself be composed of multiple serially connected chromatographic columns.

As used herein, the term “high-pressure liquid chromatography” or “HPLC” refers to a form of column chromatography used frequently in biochemistry and analytical chemistry to separate, identify, and quantify compounds. As opposed to capillary LC or microfluidic LC, where only thin capillaries (i.e., with an internal diameter in the range between 0.005 and 1 mm) are used and where as a consequence the viscous heating problem does not manifest itself, HPLC utilizes a column (metallic tube) with an internal diameter in the range of 1 to 5 mm that holds chromatographic packing material, the stationary phase, a pump that moves the mobile phases through the column, and a detector that shows the retention times of the molecules. Retention time of the compounds varies depending on the interactions between the stationary phase, the molecules being analyzed, and the solvents used.

As used herein, the terms “intermittently” or “tandemly” relate to the way the separation segments and cooling segments are arranged. The arrangement provides a series of one or more separation segments interconnected by one or more cooling segments.

The flow path of the liquid therefore subsequently passes through at least one separation segment, a cooling segment and a further separation segment. Optionally, additional cooling or separation segments may be added and repeated. Users skilled in the art of chromatography will appreciate that other segments, such as detector segments, are incorporated in between the intermittently repeating separation segments and cooling segments.

As used herein, “cooling segment” refers to a segment enabling the transfer of fluid from the end of a first separation segment towards the front a subsequent separation segment. More preferably the cooling segment comprises fluidic connection tubes such as capillaries or microfluidic channels. An important feature of said cooling segment is that the fluid flow passing through the cooling segment is actively cooled, thereby reducing the temperature of the mobile phase or sample running through the cooling segment significantly, and preferably cooling actively to the initial temperature of the mobile phase or sample at the front of the previous separation segment.

By actively cooling the fluid flow in the cooling segment heat or excess heat is dissipated or removed from said fluid. More preferably the heat is dissipated in a regulated manner, wherein the cooling is made using systems such as heat exchangers.

According to particular embodiments of the present invention, methods and devices are provided wherein one or more cooling segments are used to improve separation efficiency. More particularly, one or more cooling segments are used to remove heat from liquid having passed through an HPLC column, prior to its entry into a subsequent HPLC column. In particular embodiments, the two successive HPLC columns are commercial HPLC columns, i.e., metal tubes with a diameter in the 1 to 5 mm range. The capillary connection conduit corresponding to the “cooling segment” is cooled externally, thereby removing heat. In more particular embodiments, the cooling segment provides a cooling action between two separation segments dedicated to the same separation process. By placing one or more cooling elements at intermediate positions along the trajectory of an operation that one would normally do in one separation column, the quality of separation is improved. Therefore the high-pressure liquid chromatography system according to the present invention and its use ensure an improved separation.

In particular embodiments of the methods of the invention, the diameter of the fluid passage way of said cooling segment is smaller than the diameter of the fluid passage way of said separation segments.

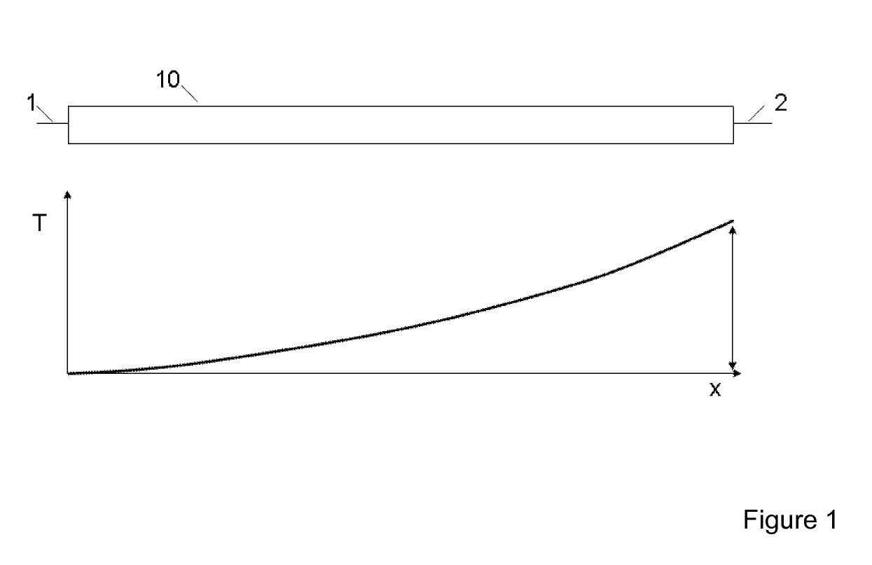

FIG. 1 shows the evolution of the temperature (T) in a single high-pressure liquid chromatography column (10) comprising a stationary phase and connecting an inlet capillary (1) to an outlet capillary (2) and operated at an ultra-high inlet pressure. Characteristic for such a single column set-up is that the temperature inside the column gradually increases along the axis of the column.

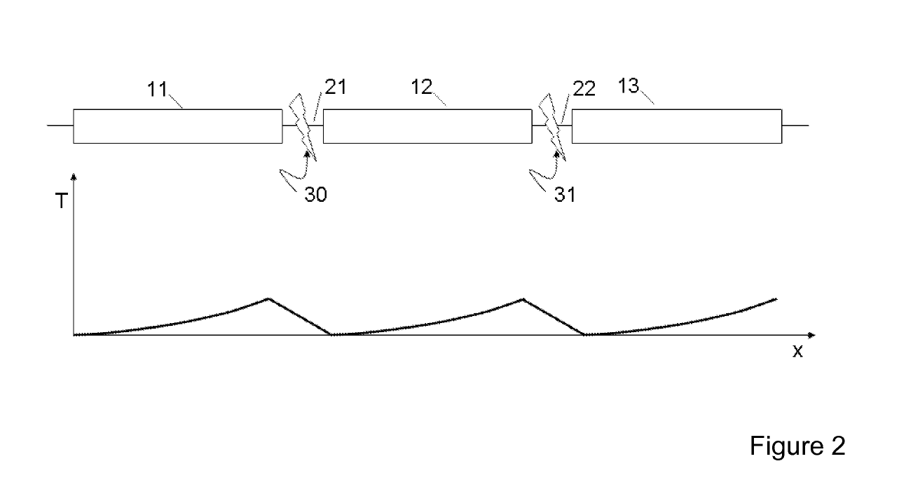

As provided by the method of the present invention, FIG. 2 shows the evolution of the temperature (T) in one of the embodiments according to the present invention, wherein the high-pressure liquid chromatography column is distributed over N separation segments (11, 12, 13), said N separation segments being serially connected by N−1 cooling segments (21, 22) and arranged with suitable temperature control means (31, 32) allowing to apply a controlled active cooling effect to said cooling segments. By distributing the high-pressure liquid chromatography column over N separation segments and by controlling the active cooling of fluid flow passing through the cooling segments the temperature rise of the fluid flowing through the separation segments is reduced when the liquid passes through the cooling segments, thereby reducing the overall temperature rise over the entire high-pressure liquid chromatography column.

Whereas FIG. 2 provides an example where N is equal to three, the high-pressure liquid chromatography column according to the present invention comprises at least 2, at least 3, at least 4, at least 5, at least 6, at least 7, at least 8, at least 9, at least 10, at least 15, at least 20 or at least 25 separation segments said separation segments being connected cooling segments.

Examples of active temperature control means known to those skilled in the art include, but are not limited to, heat exchangers, evaporative coolers, Peltier coolers, contact coolers and/or convective coolers using liquids or gases. These active temperature control means can be used for regulating the temperature of the fluid flowing through the cooling segments

In particular embodiments, the present invention relates to methods for the separation of a sample in a high-pressure liquid chromatography column wherein the method comprises the subsequent steps of,

(a) separating a sample in a first separation segment, thereby providing a partially separated sample;
(b) cooling said partially separated sample in a further cooling segment, thereby providing a cooled partially separated sample;
(c) further separating said cooled partially separated sample is a subsequent separation segment, thereby providing a further partially separated sample; and;
(d) optionally repeating one or more times the steps (b) and (c).

More preferably steps (b) and (c) are repeated at least once, at least twice, at least 3 times, at least 4 times, at least 5 times and up to 20 times or more.

In particular embodiments, the present invention relates to methods according to the present invention, wherein the fluid passage way of said cooling segment comprises a stationary phase or a dispersion reducing medium. Because the separation segments are provided with a stationary phase packed within a tube or column, the primary function of the separation segments is the chromatographic separation of a sample mixture into its different components. The primary function of the cooling segments is the cooling of the liquid passing through these segments. It should however be noted that these cooling segment may also be provided with a known packing material packed within a tube or column. Said packing material may be a material chosen from, but not limited to a stationary phase material or a dispersion reducing medium. The dispersion reducing medium is preferably a material filling the column in such a way that it reduces the axial dispersion compared to that governing an empty column. By providing cooling segments with a stationary phase, a sample mixture may be further separated into its different components in said cooling segments. It should however be noted the primary function of the cooling segments remains the cooling of the liquid passing through said segments.

In particular embodiments, the present invention relates to methods wherein the fluid passage way of said cooling segment is embedded in a heat exchanger and preferably a heat exchanger using fluid or fan cooling, thereby cooling the fluid passing through the fluid passage way of said cooling segment in an active and controlled manner. In particular embodiments said heat exchanger is thermally insulated. In particular embodiments said heat exchanger comprises tubing guiding a cooling medium over said fluid passage way, thereby cooling the fluid passing through the fluid passage way of said cooling segment.

As used herein, the term “heat exchanger” refers to a system enabling an efficient heat transfer from one medium to another. With respect to the present invention, said heat exchanger enables the adjustment of the temperature of the fluid passing through the fluid passage way of said cooling segment by appropriate cooling means and corresponding control circuitry. Preferably the method comprises passing the fluid passage way through a heat exchanger to bring the liquid inside the passage way to a predetermined temperature prior to its introduction into the subsequent separation segment. Preferably the heat exchanger uses a heat transfer medium known in the art. Preferably said heat transfer medium is water, oil, liquid nitrogen or any other heat transfer medium known in the art.

In another preferred embodiment, the walls of the separation segments are isolated using any known isolation material known in the art, such as for example insulating foam, glass fibre sheets, rubber, stagnant air, helium or a vacuum chamber. This insulation prevents radial heat loss.

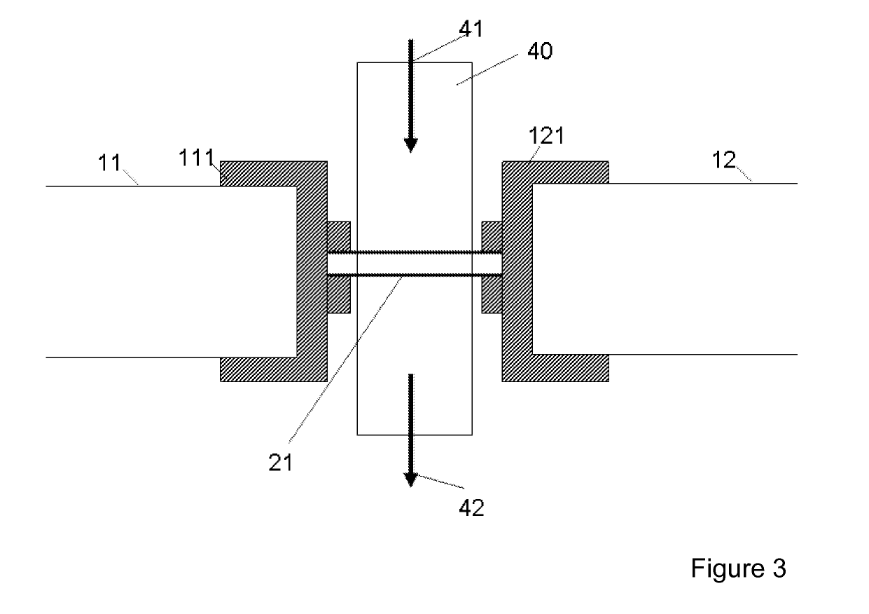

As shown in FIG. 3 and according to one of the embodiments of the present invention, a guiding tube (40) is perforated through two sealed openings with a fluid passage way (21) connecting two serially coupled separation segments (11, 12), attached to the fluid passage way using the column nuts (111, 121). The guiding tube (40) guides a cooling medium such as for instance a gas or a liquid, across the fluid passage way in the direction indicated by the arrows (41, 42). In particular embodiments, the present invention removes heat between two successive commercial HPLC columns segments, coupled using coupling nuts. The capillary connection conduit connecting the coupling nuts is cooled externally.

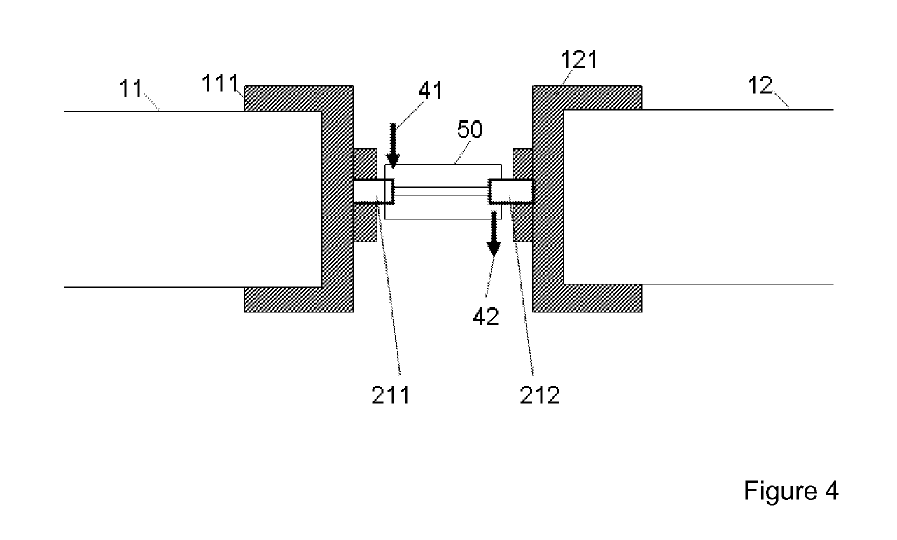

In an embodiment according to the invention illustrated in FIG. 4, the fluid passage way comprised in the cooling segment is split in two parts, with both parts (211, 212) connected to a micro-heat exchanger (50).

In particular embodiments, the methods according to the present invention relates to methods, wherein said heat exchanger controls the cooling of fluid passing through said cooling segment by receiving temperature information from at least one temperature sensor located on or in the fluid passage way of said cooling segment and/or at least one temperature sensor located at the inlet of the fluid passage way of the subsequent separation segment.

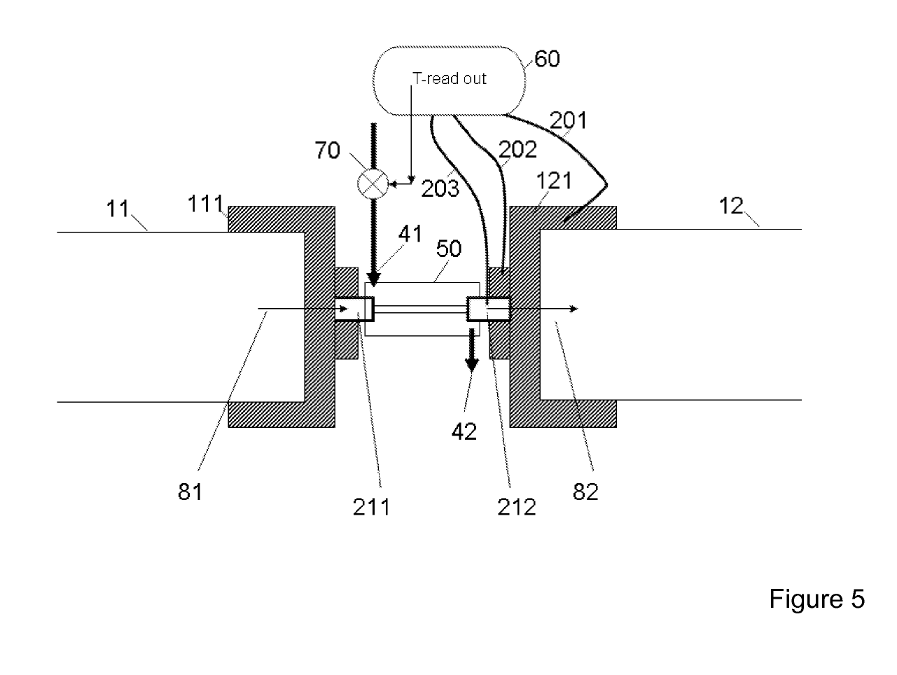

According to particular embodiments of the present invention, the flow rate and temperature of the cooling medium used to control the temperature of the liquid leaving the cooling segment is controlled as shown in FIG. 5. In FIG. 5, a control unit (60) receives information regarding the liquid temperature measured by one or more temperature sensors (201, 202, 203) located close to the end of the fluid passage way comprised in the cooling segment and/or close to the front of the separation segment proceeding it, thereby steering a flow control device (70) that regulates the flow rate and the temperature of the cooling medium. Without being limitative, these devices include heaters, coolers, pumps and gas blowers. The arrows (81, 82) indicate the direction of the mobile phase movement in the separation segments.

By using one or more temperature sensors to control the cooling means, the temperature is kept at a steady-state value during for instance gradient elution chromatography, where the continuously varying mobile phase composition is accompanied by a continuously varying viscous heat generation. Without temperature control means, this would lead to variable separation column temperatures and hence to less reproducible separation performances, that are furthermore more difficult to model and predict.

Preferably the high-pressure liquid chromatography column, separation segments and/or cooling segments are provided with pre-attached temperature sensors. Examples of temperature sensors known to those skilled in the art include, but are not limited to, thermocouples and thermistors.

According to particular embodiments of the methods according to the present invention, the temperature control device actively keeps the liquid at the outlet of the cooling segment at a temperature equal to a given set temperature. This set temperature may be any desired value, and can be equal, lower or higher than the temperature near the inlet of the proceeding separation segment.

In particular embodiments the incoming liquid is cooled below the temperature of the column wall of the preceding separation segment, so as to compensate for the parabolic band deformation that can be expected from the viscous heating effect developing along the axis of the proceeding separation segment.

Users skilled in the art of chromatography will appreciate the necessity to be able to diagnose the presence of faulty columns in a train of serially connected elements. To identify such segments, deviating temperatures measured via the temperature sensors attached to each segment during a run without active cooling can help detecting separation segments with a suddenly changed permeability.

In particular embodiments, the present invention relates to methods, wherein the fluid passage way in said cooling segment is provided with heat dissipation means.

As used herein, “heat dissipation means” refers to means enabling an optimal heat dissipation from the fluid passing through the fluid passage way in said cooling segment. Preferably heat dissipation means such as cooling fins provide means for optimal fluid or fan cooling of the fluid passage way in said cooling segment.

In particular embodiments, the present invention relates to methods, wherein the operating pressures of the high-pressure liquid chromatography are larger than 400 bar, preferably larger than 1000 bar, larger than 2000 bar, larger than 3000 bar, larger than 4000 bar, larger than 5000 bar and more preferably larger than 6000 bar.

In particular embodiments, the present invention relates to methods, wherein said cooling segments comprise at least one capillary or at least one microfluidic channel, said capillary or microfluidic channel having an internal diameter smaller than 500 μm, and more preferably smaller than 50 μm.

In some particular embodiments according to the present invention, said cooling segments preferably comprise a metal tube, a PEEK tube or a fused silica tube, with an internal diameter ranging between 0.5 μm and 2000 μm, preferably between 5 μm and 1000 μm, more preferably between 20 μm and 500 μm and most preferably between 50 μm and 500 μm.

By ensuring that the fluid passage way running through the cooling segments is sufficiently narrow, preferably narrower than 500 μm, and, even more preferably, narrower than 50 μm, the fluid passage way running through the cooling segments will allow for a swift radial elimination of the heat generated in the preceding separation segment without generating a significant viscous heat band broadening.

By ensuring that the fluid passage way running through the cooling segments is sufficiently short, preferably shorter than 10 cm, and more preferably shorter than 1 cm, the fluid passage way running through the cooling segments will not contribute significantly to the extra-column volume and therefore only have a minor effect on the separation efficiency.

Said fluid passage way running through the cooling segments preferably comprises capillaries or microchannels. Said capillaries refer to capillaries known in the art and more specifically relate to for instance open-tubular capillaries or packed capillaries. In a preferred embodiment said capillaries are arranged in a bundle of at least 2, 5, 10, 50, 100 or 1000 of said capillaries.

Therefore, multiple parallel capillaries can be used to couple two successive separation segments. The use of a parallel bundle of capillaries is highly advantageous because it allows the reduction of the linear velocity inside the individual capillaries, in turn lowering the band broadening inside the capillaries, as well as lowering the length needed for the heat transfer.

In particular embodiments of the present invention, said connection capillaries are part of a microfluidic device. A microfluidic cooling device is therefore used as a coupling channel between two successive normal bore chromatographic columns. Such microfluidic devices can be produced using the photolithographic micromachining techniques of the micro-electronics industry and allow to fabricate micro-channels with a flat-rectangular cross-section, the latter having more suitable band broadening and heat transfer characteristics than a cylindrical capillary with the same cross-section.

In particular embodiments, the present invention relates to a method according to the present invention, wherein said high-pressure liquid chromatography column comprises at least two separation segments, said at least two separation segments being serially interconnected by a cooling segment, wherein said cooling segment is cooled to an operating temperature which is substantially different from the inlet temperature of the first separation segment. In a preferred embodiment said operating temperature is larger than the inlet temperature of the first separation segment.

In particular embodiments, the present invention relates to a method according to the present invention, wherein said high-pressure liquid chromatography column comprises N separation segments, said N separation segments being serially interconnected by cooling segments, wherein a first cooling segment is cooled to a first operating temperature and wherein the further cooling segments are cooled at another operating temperature different from said first operating temperature, said first operating temperature being larger than the further operating temperatures. In a particular embodiment, the operating temperature of the first cooling segment is larger than the operating temperature of the last cooling segment, wherein the operating temperature of the intermediate cooling segment gradually decreases over said high-pressure liquid chromatography column.

When operating each separation segment at a different temperature, the first separation segment is operated at a higher temperature because the pressure in the first separation segment is inevitably higher than in the proceeding separation segments. At extremely high pressures, the molecular diffusivity in a liquid is known to decrease considerably, while the retention equilibrium is known to increase considerably. By operating the first separation segment at a higher temperature than the proceeding separation segments helps to compensate for this problem, because the effect of the temperature on both the molecular diffusivity and the retention coefficient is opposite to the effect of pressure. Consequently, a different temperature can be applied to each separation segment. An example of one suitable operating scheme, enabling an operation at 4000 bar using a high-pressure liquid chromatography column split into 4 separation segments is given in Table 1.

TABLE 1

| | Tₒᵥₑₙ | Tₛₒₗᵥₑₙₜ₋ᵢₙ | ΔP over | Tₛₒₗᵥₑₙₜ₋ₒᵤₜ | T_{cooling capillary} |
|---|---|---|---|---|---|
| Segment | (° C.) | (° C.) | column (bar) | (° C.) | (° C.) |
| 1 | 50 | 50 | 4000 to 3000 | 60 | 40 |
| 2 | 40 | 40 | 3000 to 2000 | 50 | 30 |
| 3 | 30 | 30 | 2000 to 1000 | 40 | 20 |
| 4 | 20 | 20 | 1000 to 0 | 30 | — |

To operate each separation segment at its desired temperature, each different separation segment can be put in a different division of an oven. Alternatively, the separation segments are not placed into a divided oven, but insulated from the environment using, without being limitative, for example insulating foam, glass fibre sheets, rubber, stagnant air, helium or a vacuum chamber.

If desired, for example during temperature gradient operation, the set temperature can be varied with the time according to a predefined scheme.

Another aspect of the present invention regards high-pressure liquid chromatography columns characterized therein that said columns comprises at least two separation segments and at least one cooling segment, wherein said cooling segment is arranged between at least two of said serially coupled separation segments. By providing an arrangement of cooling segments in between the separation segments, the temperature of the fluid coming out of the first separation segment can be reduced in the cooling segment prior to flowing through the subsequent separation segment. In particular embodiments, the diameter of the fluid passage way of said cooling segment is smaller than the diameter of the fluid passage way of said separation segments.

In particular embodiments of the present invention a high-pressure liquid chromatography columns for performing high-pressure liquid chromatography are provided, comprising tandemly arranged separating and cooling segments each segment being fluidically interconnected and comprising a fluid passage way. Said cooling segments actively reduce the temperature of the fluid passing through the segments.

In further particular embodiments, the present invention regards high-pressure liquid chromatography columns, wherein said columns are a distribution of N separation segments, with N being an integer number larger than 1, said N separation segments being serially connected using N−1 fluidic connections, characterized therein that active temperature control means are arranged between at least two of said serially coupled separation segments. Said active temperature control means enable the cooling or heating of said fluidic connections, and more specifically the cooling or heating of the fluid flowing through said fluidic connections.

In further particular embodiments, the present invention relates to high-pressure liquid chromatography columns according to the present invention, comprising N separating segments and N−1 cooling segments, whereby N is an integer and at least 2. More preferably, N is at least 2, 3, 4, 5, 6, 7, 8, 9, 10, 15, 20 or 25.

Users skilled in the art of chromatography will appreciate that cooling segments are not always required in between the separation segments. Cooling is primarily required after separation segments that generate a large amount of heat, especially corresponding to separation segments that are operated at high pressures.

In further particular embodiments, the present invention relates to high-pressure liquid chromatography columns according to the present invention, wherein said cooling segments are provided with active cooling means.

Examples of active cooling means known to those skilled in the art include, but are not limited to, heat exchangers, evaporative coolers, Peltier coolers, contact coolers and/or convective coolers using liquids or gases. These active cooling means can be used for regulating the temperature of the fluid flowing through the cooling segments.

In further particular embodiments, the present invention relates to high-pressure liquid chromatography columns according to the invention, wherein each cooling segment is operated at a different temperature. By operating each segment at a different temperature, and preferably by operating the first column segment at a higher temperature than the preceeding ones, it is possible to compensate for the fact that at extremely high pressures, the molecular diffusivity in a liquid is known to decrease considerably, while the retention equilibrium is known to increase considerably.

In yet further particular embodiments, the present invention relates to high-pressure liquid chromatography columns according to the present invention, wherein the fluid passage way of said separating segments comprises a stationary phase.

In yet further particular embodiments, the present invention relates to high-pressure liquid chromatography columns according to the present invention, wherein the fluid passage way of said cooling segments comprises at least one capillary or at least one microfluidic channel, said capillary or microfluidic channel having an internal diameter smaller than 500 μm, and more preferably smaller than 50 μm.

In yet further particular embodiments, the present invention relates to high-pressure liquid chromatography columns according to the present invention, wherein said fluid passage way in said cooling segment comprises at least one capillary and preferably open-tubular capillaries or packed capillaries, more preferably arranged in a bundle comprising a multitude of capillaries or at least one microfluidic channel, preferably arranged in a bundle of parallel microfluidic channels, said capillary or microfluidic channel having an internal diameter smaller than 500 μm, and more preferably smaller than 50 μm.

In particular embodiments, the present invention relates to high-pressure liquid chromatography columns according to the present invention, wherein the fluid passage way of said cooling segments comprises a bundle of capillaries.

In yet further particular embodiments, the present invention relates to high-pressure liquid chromatography columns according to the present invention, wherein the fluid passage way of said cooling segments comprises at least two microfluidic channels running in parallel.

In yet further particular embodiment, the present invention relates to high-pressure liquid chromatography columns according to the present invention, wherein said fluid passage way in said cooling segment comprises heat dissipation means.

In yet further embodiments, the present invention relates to high-pressure liquid chromatography columns according to the present invention, wherein temperature sensors located on or in the fluid passage way of said cooling and/or separation segments measure anomalous deviations in the measured intermediate temperatures, thereby providing means to identify column segments with a suddenly changed permeability.

In yet further particular embodiments, the present invention relates to high-pressure liquid chromatography columns according to the present invention, wherein said high-pressure liquid chromatography column comprises at least one temperature sensor located on or in the fluid passage way of said cooling segment and/or at least one temperature sensor located at the inlet of the fluid passage way of the subsequent separation segment.

In yet further particular embodiments, the present invention relates to high-pressure liquid chromatography columns according to the present invention, wherein fluid passage way of said cooling segment is embedded in a heat exchanger.

The present invention further relates to a capillary tube or an analytical column (i.e., a metallic tube with a diameter in the 1 to 5 mm range and packed with a stationary phase), more particularly for use in a system according to the present invention, characterized therein that a temperature sensor is attached to said capillary tube or said tube packed with a stationary phase. The temperature sensor attached to the capillary tube or the analytical column, when used in a system according to the present invention, provides a reliable estimate of the temperature of the liquid in the capillary tube or in the analytical column. This temperature information may be used to control the active cooling action in the cooling segment. Accordingly, in a particular embodiment, the capillary tube or analytical column to which the temperature sensor is attached, is not provided with a surrounding thermostat or heater body for controlling the temperature of the capillary tube or analytical column itself, as the temperature is actively controlled in the cooling segment.

Further embodiments of the present invention relate to chromatographic systems comprising an injector, preferably performing time-pulsed injections, a detector, connection capillaries, and a high-pressure liquid chromatography column according to the present invention.

### EXAMPLES

### Example 1

### Comparative Example Showing the Effect of Cooling of the Fluid Passage Way of the Cooling Segments

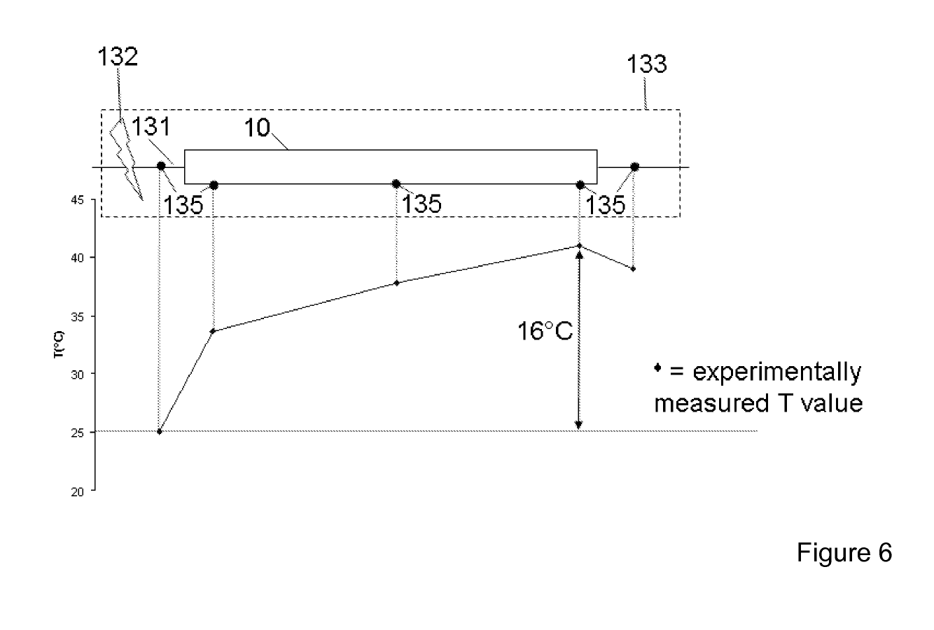

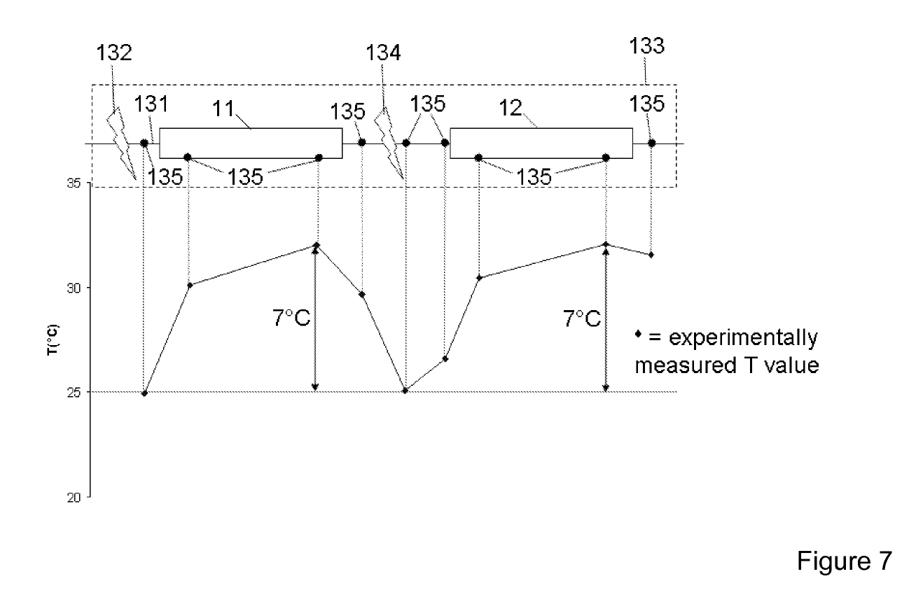

The present example provides a comparison of the temperature profile retrieved from a single 10 cm long column (10) packed with 1.7 μm particles as shown in FIG. 6, and the temperature profile retrieved from two 5 cm long separation segments (11,12) packed with 1.7 μm particles but connected through an actively cooled fluidic connection capillary which acts as the cooling segment according to the present invention and as shown in FIG. 7.

In both systems, the separation column(s) were placed into a column oven (133) of a commercial chromatograph. The temperature was measured using thermocouples (135) placed on various locations of the separation columns and fluidic interconnection capillaries. In both cases, a flow rate was 0.45 ml/min of pure methanol was flown through the set-up, resulting in a total system pressure drop of about 900 bar. The incoming solvent (131) was preheated to the oven temperature (25° C.) using a heat exchanger (132). Where two separation columns were used (FIG. 7), an intermittent heat exchanger (134) was set to the same temperature (25° C.). The outlet temperature of the single separation column is 41° C., whereas the outlet temperature of separation system comprising two separation columns is 32° C.

This experiment shows that the maximum measured increase in temperature was a less than half the increase obtained for the single column system. This has been done without changing the total length of the separation column.

### Example 2

### Comparative Example Showing the Effect of Cooling of the Fluid Passage Way between Two Separation Segments

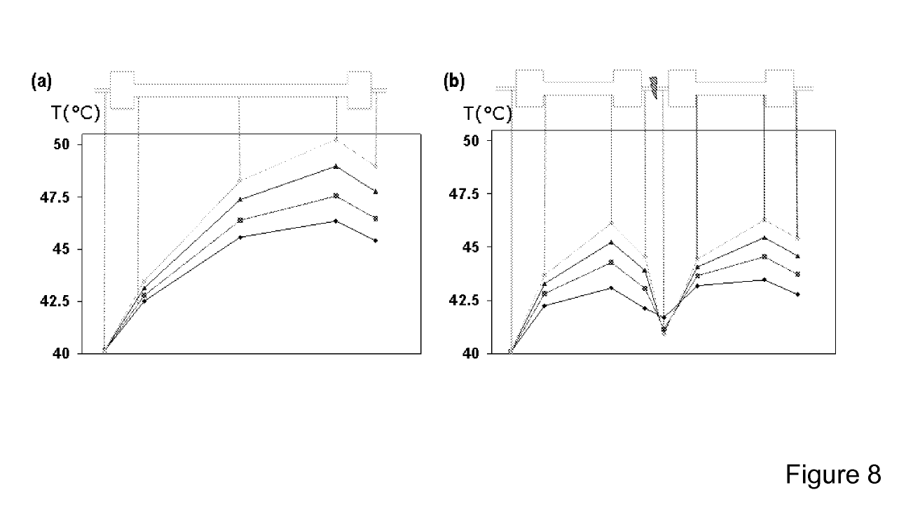

The present example provides a comparison of the temperature profile retrieved from a 10 cm long column (FIG. 8, left) and two coupled 5 cm long columns (FIG. 8, right) with intermediate active cooling according to the present invention.

A comparison of the experimentally measured temperatures of the column and capillary walls is shown in FIG. 8. The thermal behaviour of one 10 cm long column (a) is compared with that of two coupled 5 cm columns (b) with intermediate active cooling for the flow rates (from top to bottom) of 0.49, 0.425, 0.35 and 0.24 ml/min of a 60/40% (v/v) MeOH/H2O mixture at 40° C. in still air conditions.

This shows that the use of a coupled column system with active cooling applied to the intermediate connection capillaries is shown to be a promising solution for the removal of the generated heat by viscous friction in high pressure liquid chromatography columns. Therefore, splitting up a column into different segments (n=the number of segments) with active intermediate cooling allows to limit the total increase of the mobile phase temperature to that occurring in the first 1/nth-part of the single column reference system.

### Example 3

### Comparative Example Showing the Effect of Active Cooling of the Fluid Passage Way between Three Separation Segments

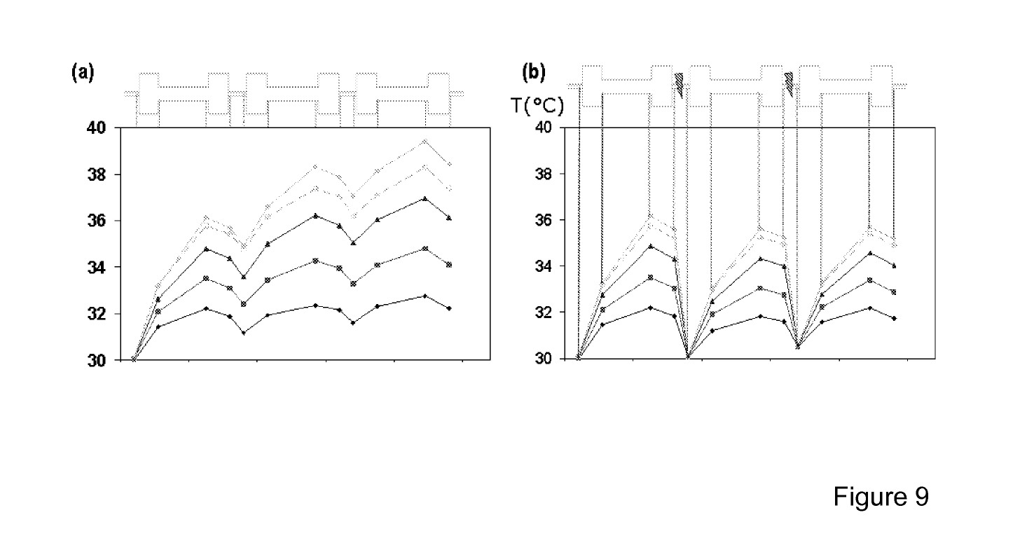

The present example provides a comparison of the of the temperature profile retrieved from two three-segment systems (3×5 cm), one without (FIG. 9a) and one with active cooling (FIG. 9b). In this setup, the columns as well as the connection capillaries were all insulated (using commercial tubing insulation) from the surrounding air and placed in the temperature controlled compartment of the instrument.

A comparison of the experimentally measured temperatures of the column and capillary walls is shown in FIG. 9. By comparing a coupled system with three insulated columns, without (a) and with (b) active cooling applied, at flow rates of (top to bottom) 0.6, 0.5, 0.4 and 0.3 ml/min of a 45/55% (v/v) ACN/H₂O mixture at 30° C.

The temperature profiles in FIG. 9b show that the temperature distribution in each of the segments of the 15 cm length column system is more or less identical to that in a single 5 cm long column operated at this flow rate. This approach, wherein a column is split up into different segments that all operate under the low viscous heating conditions, can in principle be applied ad infinitum.

This shows the importance of active cooling of a coupled column system. Whereas a limited effect is seen when no active cooling is applied, the active cooling is shown to be important to limit the total increase of the mobile phase temperature.

### Example 4

### Effects of Active Cooling on the Separation Efficiency and Selectivity

When comparing the performance of a single column (10 cm) with that of a two coupled segment system (2×5 cm) with intermediate active cooling, the efficiency of the entire system does not seem to be affected (data not shown). Therefore the segmentation of a 10 cm column into two 5 cm segments does not lead to an unallowable loss in efficiency. The thermal conditions however have a clear effect on the two coupled segment system which provides a slightly better performance compared to the single column system. This is due to the smaller temperature differences between the column and the environment.

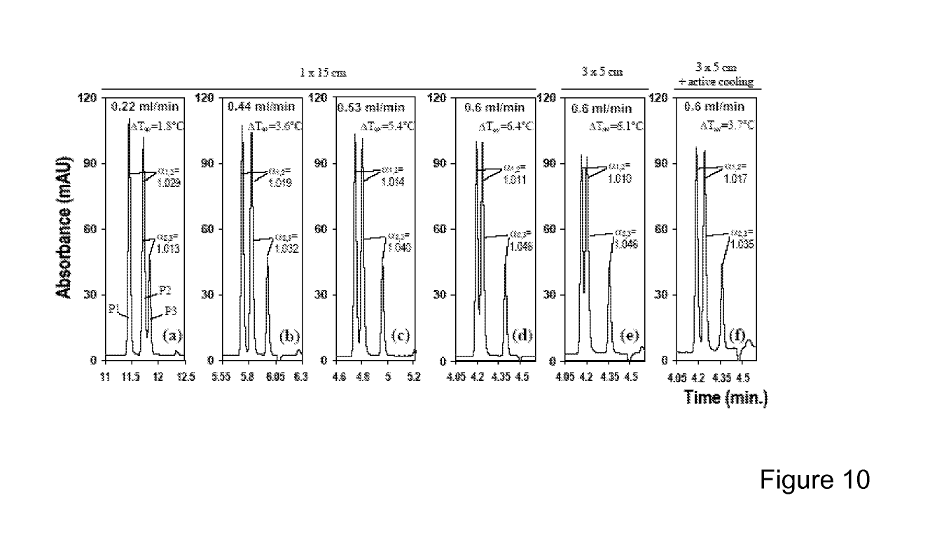

With respect to the selectivity FIG. 10 provides a comparison of recorded chromatograms of three impurities in metoclopramide hydro-chloride formulations using a gradient separation. FIG. 10(a-d) represent the observed results on a 15 cm long column with increasing flow rate, (e) shows at the chromatogram at the same flow rate but for a coupled system without active cooling and (f) represent the same experiment but now with the active cooling on.

For a single column, it can be observed that the selectivity between the different components shifts considerably because of the increased temperature, in turn caused by an increase in flow rate and hence operating pressure. With increased flow rate, the selectivity of the separation is drastically influenced in a negative way as compared to the selectivity of the original separation (FIG. 10a). The same selectivity shift is noted for the system with 3 coupled 5 cm columns without active cooling (FIG. 10e), although this system already exhibits a slightly lower temperature increase. FIG. 10f shows the same system as in FIG. 10e but now with the active cooling switched on. As can be clearly observed, the selectivity shift is now smaller than in the case without active cooling.

The intermediate cooling therefore improves the selectivity at the highest flow rate compared to the single column. In fact, the shift in selectivity is of the same order as that obtained in the single column system for a flow rate of 0.44 mL/min.

Therefore the system according to the present invention provides a system with an at least equal efficiency and improved selectivity compared to a system without active cooling. The improved temperature control allows to more closely maintain the low pressure selectivity of the separation when switching to a faster method at higher pressures. Furthermore, it has been observed that the intermediate active cooling technique also leads to a faster thermal equilibration of the column system, resulting in more reproducible results of separations and faster thermal re-equilibration of the columns after e.g. gradient runs or changes in flow rate.

1.-15. (canceled)

16. Method for the separation of a sample in a high-pressure liquid chromatography column, wherein said sample is forced through a separation segment of said column, subsequently cooled in a cooling segment of said column wherein an active controlled cooling action is applied and further forced through a subsequent separation segment of said column, wherein the diameter of the fluid passage way of said cooling segment is smaller than the diameter of the fluid passage way of said separation segments.

17. Method according to claim 16, comprising the subsequent steps of,
(a) separating said sample in said first separation segment, thereby providing a partially separated sample;
(b) cooling said partially separated sample in said further cooling segment, thereby providing a cooled partially separated sample;
(c) further separating said cooled partially separated sample in said subsequent separation segment, thereby providing a further partially separated sample; and;
(d) optionally repeating once or more the steps (b) and (c).

18. Method according to claim 16, wherein said fluid passage way of said cooling segment comprises a stationary phase or a dispersion reducing medium.

19. Method according to claim 16, wherein said fluid passage way of said cooling segment is embedded in a heat exchanger and preferably a heat exchanger using fluid or fan cooling.

20. Method according to claim 19, wherein said heat exchanger controls the cooling of fluid passing through said cooling segment by receiving temperature information from at least one temperature sensor located on or in the fluid passage way of said cooling segment and/or at least one temperature sensor located at the inlet of the fluid passage way of the subsequent separation segment.

21. Method according to claim 16, wherein the operating pressures of said high-pressure liquid chromatography are larger than 400 bar, and preferably larger than 1000 bar.

22. Method according to claim 16, wherein said separation segments having a cooling segment between them contain the same stationary phase.

23. Method according to claim 16, wherein said separation segments having a cooling segment between them are completely identical.

24. A high-pressure liquid chromatography column for performing the method according to claim 16 characterized therein that said column comprises at least two separation segments and at least one cooling segment wherein an active controlled cooling action is applied, wherein said cooling segment is arranged between at least two of said serially coupled separation segments, and wherein the diameter of the fluid passage way of said cooling segment is smaller than the diameter of the fluid passage way of said separation segments.

25. High-pressure liquid chromatography column according to claim 24, comprising N separating segments and N−1 cooling segments, whereby N is an integer and at least 2.

26. High-pressure liquid chromatography column according to claim 24, wherein said cooling segments are provided with active cooling means.

27. High-pressure liquid chromatography column according to claim 24, wherein each cooling segment is operated at a different temperature.

28. High-pressure liquid chromatography column according to claim 24, wherein the fluid passage way of said cooling segments comprises at least one capillary or at least one microfluidic channel, said capillary or microfluidic channel having an internal diameter smaller than 500 μm, and more preferably smaller than 50 μm.

29. High-pressure liquid chromatography column according to claim 28, wherein said fluid passage way of said cooling segments comprises a bundle of capillaries or at least two microfluidic channels running in parallel.

30. High-pressure liquid chromatography column according to claim 24, wherein temperature sensors located on or in said fluid passage way of said cooling and/or separation segments measure anomalous deviations in the measured intermediate temperatures, thereby providing means to identify column segments with a suddenly changed permeability.

31. High-pressure liquid chromatography column according to claim 24, wherein said separation segments having said cooling segment between them contain the same stationary phase.

32. High-pressure liquid chromatography column according to claim 24, wherein said separation segments having said cooling segment between them are completely identical.

33. A chromatographic system comprising an injector, a detector, connection capillaries, and a high-pressure liquid chromatography column according to claim 24.
